(19) United States
(12) Patent Application Publication
(10) Pub. No.: US 2009/0167681 A1
(43) Pub. Date: Jul. 2, 2009

(54) ELECTRONIC APPARATUS

(75) Inventor: Hironori MOTOE, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/342,421

(22) Filed: Dec. 23, 2008

(30) Foreign Application Priority Data
Dec. 27, 2007 (JP) 2007-338207

(51) Int. Cl. G06F 3/033

(52) U.S. Cl. 345/157

(57) ABSTRACT

According to one embodiment, a pointing device includes a detection IC mounted on a printed circuit board, a lens member provided to cover a top surface of the detection IC, and a finger guide member provided on the board to cover the detection IC and the lens member. The finger guide member includes a finger guide surface depressed lower than a top surface of a housing, and a close contact surface provided in the center of the finger guide surface, and protruding outwardly. The close contact surface is located at a position depressed lower than the top surface of the housing.

### CROSS-REFERENCE TO RELATED APPLICATIONS

This application is based upon and claims the benefit of priority from Japanese Patent Application No. 2007-338207, filed Dec. 27, 2007, the entire contents of which are incorporated herein by reference.

### BACKGROUND

1. Field

One embodiment of the invention relates to an electronic apparatus such as a portable computer, and the like and, more particularly, to an electronic apparatus provided with an optical pointing device for optically detecting a movement of a finger to move a pointer displayed on a screen.

2. Description of the Related Art

Heretofore, as an electronic apparatus provided with an optical pointing device, a personal digital assistant (cellular phone) in which an optical pointing device is attached to a through-hole formed in the outer case is known. It is disclosed in, for example, Jpn. Pat. Appln. KOKAI Publication No. 2002-62983 (pp. 5-7, FIG. 1).

The pointing device of the cellular phone disclosed in the above patent document, Pat. Document 1, is provided with a transparent finger plate which has a substantially spherical shape, and is so attached to the outer case as to allow it to protrude from the inside of the outer case to the outside via the through-hole. In this pointing device, a finger moved along the external surface of the finger plate in contact with the surface is irradiated with light from inside the finger plate, the reflected light is detected, and the pointer displayed on the screen is moved in accordance with the detected movement of the finger.

Further, the finger plate is provided to protrude from the outer case of the cellular phone, and can be depressed as a determination switch.

That is, the finger plate is attached to the outer case in such a manner that it protrudes from the case to the outside, and can be protruded or retracted from or into the through-hole, and hence the finger can be basically moved along the surface of the finger plate in a state where the finger is pressed against the surface of the finger plate in close contact with the surface, and the movement of the pattern (fingerprint) of the finger can be detected with relatively high sensitivity. However, there are some variations in the finger plate disclosed in this Pat. Document 1, and some variations in which the plate surface is covered with an opaque guide member are disclosed.

For example, a finger plate shown in FIG. 5(a) of Pat. Document 1 is provided with an annular opaque guide (hemming section 10) having a relatively large opening part in substantially the center of the plate surface. A circular transparent section 9 which swells out externally is provided in the center of the guide. When this finger plate is used, although it is possible to slide the finger along the surface of the transparent section 9 while pressing the finger against the transparent section 9, the externally swelling transparent section 9 may contact a foreign object, which may lead to the imaging region being scratched.

That is, in this example, the central part of the finger plate is protruded toward the outside of the outer case of the cellular phone so that the finger plate may function as the above-mentioned determination switch, and hence the central part of the finger plate is brought into contact with a foreign object, and is easily scratched. If the imaging region in the central part of the finger plate is damaged as described above, the refractive index of light transmitted through the finger plate is changed, the detection capability of the finger is deteriorated, and it becomes impossible for the pointing device to perform a stable operation.

Further, the surface of the imaging region in the center of the finger plate is given a mirror-finished surface so as not to lower the detection sensitivity. Thus, as in the case of the finger plate of FIG. 5(a), when the area at which the finger plate is brought into contact with the finger becomes large, the frictional force acting between the finger plate and the finger becomes large, smoothness of the sliding of the finger becomes deteriorated. If the smoothness of the sliding of the finger is lowered, the movement of the pointer is also affected, and the operability becomes poor.

On the other hand, as for the finger plate shown in FIGS. 5(b) to 5(f), although the moving direction of the finger can be guided by a guide provided on the surface of the plate, even when the finger is attempted to be pressed against the imaging region, a gap is formed between the finger and the surface of the plate, and thus the finger cannot be strongly pressed against the imaging region of the surface of the plate. As described above, if a gap is formed between the finger and the imaging region of the finger plate, the detection capability of the fingerprint is deteriorated, and a stable operation cannot be performed as the pointing device.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiment of the invention and not to limit the scope of the invention.

FIG. 1 is an external perspective view showing an electronic apparatus provided with an optical pointing device according to an embodiment of the present invention;

FIG. 2 is a block diagram showing a control system of the electronic apparatus of FIG. 1;

FIG. 3 is a partial enlarged cross-sectional view of the electronic apparatus of FIG. 1 along line III-III; and

FIG. 4 is an external perspective view showing a finger guide member of the pointing device of FIG. 1.

### DETAILED DESCRIPTION

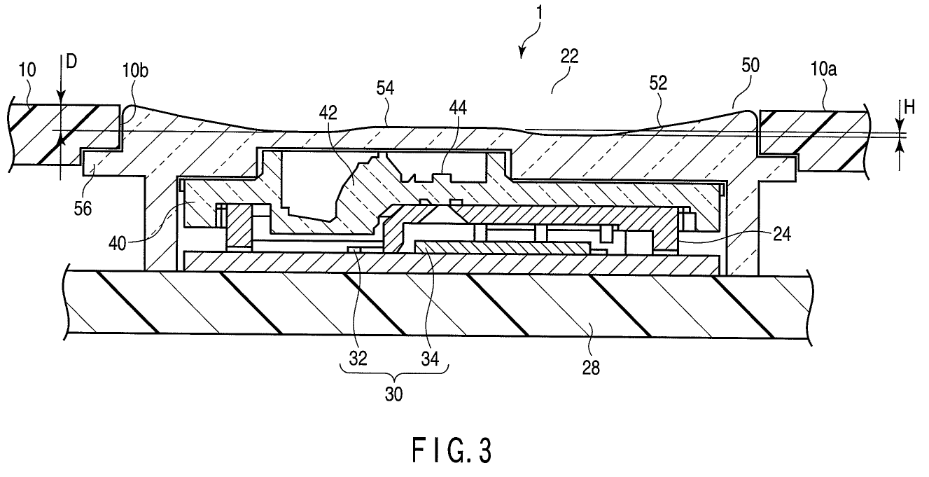

Various embodiments according to the invention will be described hereinafter with reference to the accompanying drawings. In general, according to one embodiment of the invention, a pointing device 1 includes, as shown in FIG. 3, a detection IC 24 mounted on a printed circuit board 28, a lens member 40 provided to cover the top surface of the detection IC 24, and a finger guide member 50 provided on the board 28 to cover the detection IC 24 and the lens member 40. The finger guide member 50 includes a finger guide surface 52 depressed lower than the top surface 10a of the housing 10, and a close contact surface 54 provided in the center of the finger guide surface 52, and protruding outwardly.

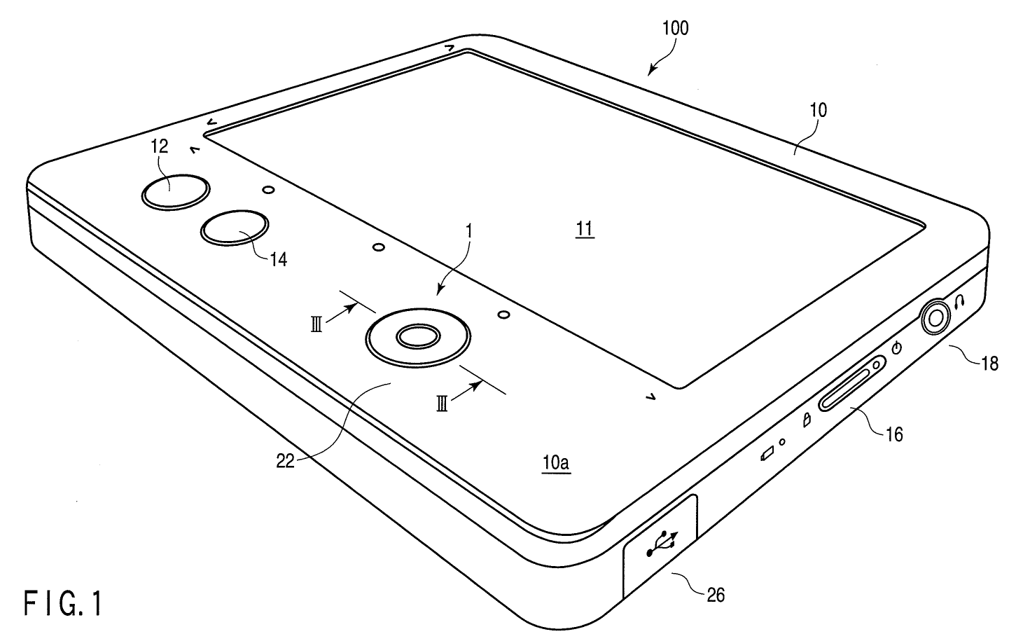

FIG. 1 shows an external perspective view of a portable computer 100 (hereinafter simply referred to computer 100) which can be driven by a battery as an electronic apparatus according to an embodiment of the present invention.

The computer 100 is a so-called palmtop computer having a size that can be held on a palm of a user, and is provided with a thin rectangular box-like housing 10. In this housing 10, various electronic components constituting the computer 100 are incorporated. On a top surface 10a of the housing 10, a display device 11 constituted of a liquid crystal display (LCD) and the like is arranged with a display screen thereof exposed to the outside. This display device 11 may be realized by a touch screen device that can detect the point touched.

Further, on the top surface 10a of the housing 10, an optical pointing device 1 (hereinafter simply referred to as a pointing device 1), and button switches 12 and 14 are arranged. The pointing device 1 optically detects a movement of a pattern (fingerprint, in this case) of an object such as a finger. This pointing device 1 includes a detection area 22 (also called a sensing area 22) arranged on the top surface 10a of the housing 10, and an optical position detection IC 24 (not shown here) incorporated in the housing 10.

When a user moves a finger back and forwards, and right and left along the top surface of the housing in a state where the finger is placed on the detection area 22 of the pointing device 1, the movement of the pattern of the finger is detected by the pointing device 1. The term “back and forwards” mentioned herein is the direction of the short sides of the display device 11, and the “right and left” direction is the longitudinal direction of the display device 11. That is, the pointing device 1 detects the movement of the finger in the surface direction along the top surface 10a of the housing 10.

That is, the optical position detection IC 24 (hereinafter simply referred to as the detection IC 24) irradiates the detection area 22 with light from inside the housing 10, detects light reflected from the object, and detects the movement of the pattern of the object by using the reflected light. Incidentally, the detection IC 24 can be realized by an image sensor.

Each of the button switches 12 and 14 inputs an event instructing to execute a function assigned to the button switch 12 or 14. Each of the button switches 12 and 14 is constituted of a circular switch operation section arranged on the top surface 10a of the housing 10 to be exposed, and a switch detection circuit (not shown) incorporated in the housing 10.

Two switch detection circuits corresponding to the detection IC 24 of the pointing device 1, and the button switches 12 and 14 are mounted on a printed circuit board 28 (to be described later) incorporated in the housing 10.

Further, a power button 16, an earphone jack 18, a USB port 26, and the like are provided on the right side surface of the housing 10.

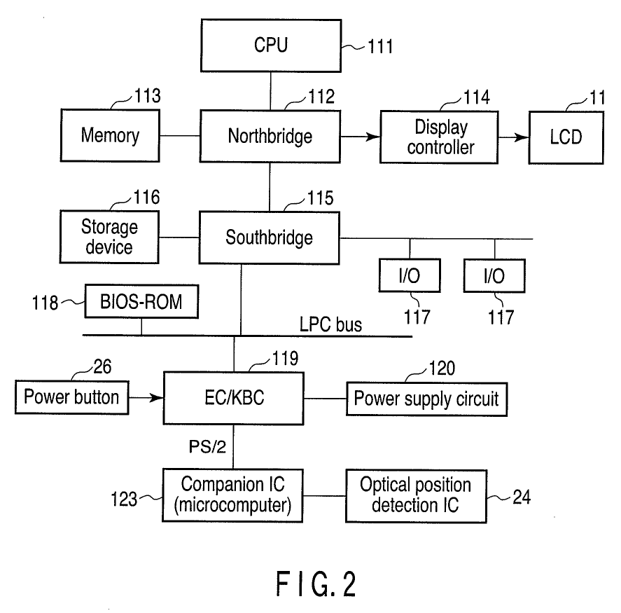

FIG. 2 shows a block diagram for explaining the system configuration of the computer 100 described above.

The computer 100 includes a CPU 111, northbridge 112, memory 113, display controller 114, southbridge 115, storage device 116 constituted of a hard disk drive or a nonvolatile semiconductor memory, or the like, various I/O devices 117, BIOS-ROM 118, embedded controller/keyboard controller IC (EC/KBC) 119, power supply circuit 120, optical position detection IC 24, companion IC 123, and the like.

The CPU 111 is a processor provided to control the operation of the computer 100, and executes the operating system and various application programs loaded from the storage device 116 into the memory 113. Further, the CPU 111 also executes the basic input output system (BIOS) stored in the BIOS-ROM 118. This BIOS is a program for hardware control.

The northbridge 112 is a bridge device for connecting the local bus of the CPU 111 and the southbridge 115 to each other. A memory controller for access-controlling the memory 113 is also incorporated in the northbridge 112. Further, the northbridge 112 is also provided with a function of executing communication with the display controller 114 through the PCI Express bus or the like.

The display controller 114 controls the display device 11 such as an LCD used as a display monitor of the computer 100.

The southbridge 115 incorporates therein an interface controller for controlling the storage device 116. Further, the southbridge 115 also executes communication with each device on the low pin count (LPC) bus.

The embedded controller/keyboard controller IC (EC/KBC) 119 is a one-chip microcomputer in which an embedded controller (EC) for power management, and a keyboard controller (KBC) for controlling the keyboard and the pointing device are integrated with each other. The EC/KBC 119 is provided with a function of turning on/off the power of the computer 100 in accordance with an operation of the power button 16 performed by the user. Control of turning on/off the power of the computer 100 is executed by the cooperation between the EC/KBC 119 and the power supply circuit 120. Further, The EC/KBC 119 is also provided with a function of executing communication with the detection IC 24 through the companion IC 123.

The detection IC 24 outputs, in accordance with the movement of the pattern of the object in the detection area 22 including the transparent region, two-dimensional movement amount information indicating an amount of movement of the pattern in each of the right-and-left direction (X), and the back-and-forwards direction (Y).

The detection IC 24 includes a sensor section 30 for detecting the movement of the pattern as shown in FIG. 3. The sensor section 30 includes an LED 32 serving as a light source for irradiating the detection area 22 with light (illumination light), and an image sensor 34 serving as a detection section for detecting the movement of the pattern of the object by receiving the reflected light from the object.

The image sensor 34 periodically receives an image (for example, a fingerprint) of the pattern of the object on the detection area 22, and calculates a movement amount of the pattern in each of the right-and-left directions (X), and the back-and-forwards directions (Y) in accordance with a result of comparison between the latest image that has been currently received, and the image input immediately before that. The two-dimensional movement amount information indicating the calculated amount of movement of the pattern in each of the right-and-left directions (X), and the back-and-forwards directions (Y) is transmitted from the detection IC 24 to the companion IC 123.

The companion IC 123 is an IC for executing an interface with the EC/KBC 119, the companion IC 123 is realized by a one-chip microcomputer and the like. This companion IC 123 converts the movement amount information received from the detection IC 24 into a predetermined movement amount signal having a signal format such as a format for the PS/2 interface, and the like, and transmits the signal to the EC/KBC 119.

FIG. 3 shows a partial enlarged cross-sectional view of a cross section obtained by dividing the pointing device 1 shown in FIG. 1 into two equal parts on the back side and on the front side viewed from the direction of arrows III-III.

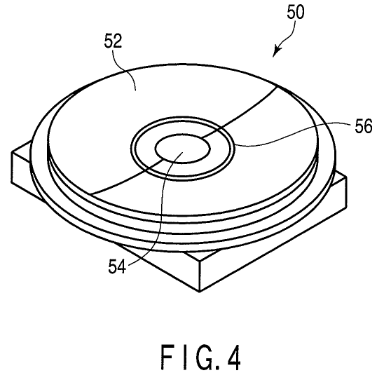

The pointing device 1 includes, as described above, the detection IC 24 mounted on the printed circuit board 28, the transparent lens member 40 arranged to cover the top surface side of the detection IC 24, and the finger guide member 50 arranged on the printed circuit board 28 to cover the entire lens member 40. FIG. 4 shows an external perspective view of the finger guide member 50.

The lens member 40 includes, as one body, a light transmission section 42 for transmitting light of the LED 32 thrown from the inside of the housing 10 toward the center of the finger guide member 50 having a substantially circular external appearance, and a lens section 44 for condensing reflected light from the object incident thereon through the finger guide member 50 onto the image sensor 34, and is formed of a transparent resin.

The finger guide member 50 has a substantially annular finger guide surface 52 which is gradually depressed lower than the top surface 10a (surface) of the housing 10 of the computer 100, and is inwardly curved. A depth D of the bottom of the finger guide surface 52 from the top surface 10a is designed to be a depth of about 1 to 2 [mm]. Further, a diameter of the finger guide surface 52 is designed to be about 13 to 15 [mm]. Furthermore, the finger guide surface 52 is grained in order to improve the sliding of the finger.

The finger guide surface 52 needs to have a diameter equal to or larger than 13 [mm] which allows the finger to enter the surface 52. It is desirable for the diameter to be 15 [mm] or less, due to the requirement that the space for the component layout on the top surface 10a of the housing 10 should be as small as possible. Further, the depth D of the finger guide surface 52 is determined by a height H of the close contact surface 54, to be described below, and it is sufficient if the depth D is a depth that does not allow the close contact surface 54 to protrude outside the top surface 10a of the housing 10.

The substantially circular close contact surface 54 arranged concentric with the finger guide surface 52 is provided in the center of the concave finger guide surface 52. This close contact surface 54 is formed of a transparent material, the surface thereof is mirror-finished, and the surface 54 is formed into a convex shape curved outwardly. The protrusion height H of the close contact surface 54 from the finger guide surface 52 is designed to be about 0.5 to 1.5 [mm], which is smaller than the depth D of the finger guide surface 52. That is, the close contact surface 54 is arranged at a position inwardly depressed lower than the top surface 10a of the housing 10, and is prevented from being scratched through contact with a foreign object. Incidentally, the outer circumference of the close contact surface 54 and the inner circumference of the finger guide surface 52 are gently continued from each other, and an ornamental ring shown in FIG. 1 may be provided between them.

The diameter of the close contact surface 54 is designed to be about 3 to 6 [mm]. Although this diameter differs depending on the type of the image sensor 34, it is desirable for the diameter to be the minimum necessary diameter so that the signal noise of the reflected light detected by the image sensor 34 can be made as small as possible. If the diameter of the close contact surface 54 exceeds 6 [mm], the operation of the pointing device 1 becomes unstable owing to the influence of the signal noise. Incidentally, the parts of the above-mentioned finger guide surface 52 and the close contact surface 54 exposed to the outside the top surface 10a of the housing 10 function as the above-mentioned detection area 22.

When the pointing device 1 having the structure described above is assembled, the detection IC 24 is mounted on the printed circuit board 28, and the lens member 40 is arranged to cover the top surface of the detection IC 24. Further, the finger guide member 50 is placed and arranged on the printed circuit board 28 to cover the detection IC 24 and the lens member 40. Further, a flange part 56 outside the finger guide surface 52 of the finger guide member 50 is fitted in a mounting hole 10b of the housing 10, and the finger guide member 50 is attached to the housing 10 from inside the housing 10.

As described above, according to this embodiment, the finger guide surface 52 is gently curved inwardly from the top surface 10a of the housing 10 of the computer 100, and hence it is possible to smoothly slide the finger in contact with the finger guide surface 52 while the finger is kept in close contact with the surface 52, and improve the operability. Particularly, since the finger guide surface 52 is grained, sliding of the finger can be made smoother than in the case of a mirror-finished surface.

Further, according to this embodiment, the close contact surface 54 provided in the center of the finger guide surface 52 is outwardly curved to be protruded, and hence it is possible to allow the close contact surface 54 to be brought into good contact with the finger moving along the finger guide surface 52 in close contact with the surface 52, and enhance the detection accuracy of the fingerprint. In other words, the user can securely press his or her finger against the close contact surface 54 merely by sliding the finger along the finger guide surface 52 without strongly pressing the finger against the surface 54.

Particularly, in this embodiment, the diameter of the close contact surface 54 is made the minimum necessary dimension, and the area of the mirror-finished surface of the close contact surface 54 can therefore be made as small as possible, and the sliding of the finger is not hindered.

Further, according to this embodiment, only the close contact surface 54 serving as a region in which the finger is actually sensed is protruded from the center of the finger guide surface 52, and hence the user can easily sense the part with which his or her finger should be brought into close contact. Further, the user can securely bring his or her finger into close contact with the close contact surface 54 without pressing the finger against the surface 54 with force, and the detection sensitivity of the fingerprint can be further enhanced.

Furthermore, according to this embodiment, the protrusion height of the close contact surface 54 protruded from the bottom of the finger guide surface 52 is designed at a position inwardly depressed lower than the top surface 10a of the housing 10, and hence it is possible to prevent a problem that a foreign object is unguardedly brought into contact with the close contact surface 54 from occurring, and prevent the close contact surface 54 from being scratched. As a result of this, it becomes possible to maintain the mirror-finished state of the close contact surface 54 for a long period of time, and enable a stable operation for a long period of time.

While a certain embodiment of the inventions has been described, this embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

For example, in the embodiment described above, the case where the finger guide surface 52 of the pointing device 1 is made circular has been described. However, the invention is not limited to this, and other shapes such as an elliptic shape and the like may be employed. Further, in the embodiment described above, in the finger guide member 50, the finger guide surface 52 and the close contact surface 54 are made integral with each other. However, the invention is not limited to this, and the part of the close contact surface 54 may be configured in such a manner that the part can be protruded or depressed from the finger guide surface 52, to be utilized as a determination key.

What is claimed is:

1. An electronic apparatus provided with an optical pointing device for optically detecting a movement of an object, and configured to move a pointer displayed on a screen in accordance with the movement of the object detected, wherein
the optical pointing device comprises:
an object guide member provided with an object guide surface, inwardly curved and depressed lower than a top surface of the electronic apparatus, and a transparent adhered surface outwardly curved with respect to the moving object while the object is in contact with the object guide surface;
a light source configured to illuminate the moving object in contact with the adhered surface from inside the adhered surface; and
a detector configured to receive light reflected from the moving object in contact with the adhered surface in order to detect the movement of the object.

2. The electronic apparatus of claim 1, wherein the adhered surface is arranged inside the top surface of the electronic apparatus.

3. The electronic apparatus of claim 2, wherein the protrusion height of the adhered surface from the finger guide surface is 0.5 to 1.5 [mm].

4. The electronic apparatus of claim 3, wherein the object guide surface and the adhered surface are formed into substantially circular shapes concentric with each other, and diameters of the circular shapes are 13 to 15 [mm], and 3 to 6 [mm], respectively.

5. The electronic apparatus of claim 1, wherein the object guide surface is grained.
